(19) United States
(12) Patent Application Publication
(10) Pub. No.: US 2022/0090383 A1
(43) Pub. Date: Mar. 24, 2022

(54) ROOF GUTTER SYSTEM

(71) Applicant: PROFESSIONAL INNOVATORS PTY LTD, O'Connor (AU)

(72) Inventor: Michael John LANYON, O'CONNOR (AU)

(21) Appl. No.: 17/481,888

(22) Filed: Sep. 22, 2021

(30) Foreign Application Priority Data
Sep. 24, 2020 (AU) 2020903439

(51) Int. Cl. E04D 13/076; E04D 13/072; E04D 13/064; G01W 1/14

(52) U.S. Cl. CPC E04D 13/076; E04D 13/0725; H02S 99/00; G01W 1/14; E04D 13/0645

(57) ABSTRACT

A rotatable roof gutter system comprises an elongate trough that has a longitudinal axis and an open top end for receiving rainwater therein. A bracket assembly rotatably attaches the trough to a building relative to an eave of a roof of the building. The bracket assembly is configured such that the trough is rotatable about the longitudinal axis between a first position and a second position. In the first position, the open top end faces away from an edge of the eave. In the second position, the open top end is positioned to catch rainwater flowing off the edge of the eave. The system also comprises a moisture detector for detecting rainwater falling onto the roof and a drive assembly operatively connected to the moisture detector. The drive assembly rotates the trough from the first position to the second position in response to rainwater being detected by the moisture detector.

### FIELD

The present invention relates to roof gutters and, more particularly, to an automated rotatable roof gutter system.

### BACKGROUND

Gutter systems are commonly used to drain rainwater off buildings and structures. A gutter system typically comprises an elongate trough that is attached to the fascia of a building. The trough is arranged such that it catches rainwater flowing off the edge of an eave of the building's roof. The rainwater flows along the trough towards an end of the trough that has a fluid outlet connected to a drainage downpipe.

Over time, a substantial amount of debris and litter can accumulate in the trough of a gutter system. For example, falling leaves can easily get trapped in the trough which can impede water drainage and lead to blockages, including in the downpipes. Blockages can lead to rainwater finding its way into the building's walls, roof space and internal cavity which can cause significant structural damage. Particularly in hot climates, accumulated debris and litter also presents a fire hazard. In cold climates, snow accumulating in a trough can eventually lead to the trough breaking due to the weight of the snow.

A gutter system must, therefore, be periodically cleaned by a person in order to remove accumulated debris. Cleaning a gutter trough is difficult because the open top end must be accessed. This can be done by arranging a ladder against the building or by climbing onto the building's roof. These approaches present a safety risk and can potentially cause damage to the roof and trough. A typical gutter system may remain unused for a substantial period of time during which the gutter will not receive or drain any rainwater. Large amounts of debris can accumulate in the gutter during this period which can render the gutter system entirely ineffective when it eventually rains.

In this context, there is a need for improved roof gutter systems.

### SUMMARY

According to the present invention, there is provided a rotatable roof gutter system, comprising:

an elongate trough that comprises a longitudinal axis and an open top for receiving rainwater into the elongate trough;

a bracket assembly for attaching the elongate trough rotatably to a building relative to an eave of a roof of the building, wherein the bracket assembly is configured such that the elongate trough is rotatable about the longitudinal axis between a first position and a second position, whereby in the first position the open top faces away from an edge of the eave and in the second position the open top is positioned to catch rainwater flowing off the edge of the eave;

a moisture detector for detecting rainwater falling onto the roof; and

a drive assembly operatively connected to the moisture detector, wherein the drive assembly rotates the elongate trough from the first position to the second position in response to rainwater being detected by the moisture detector.

The drive assembly may rotate the elongate trough from the second position back to the first position when the moisture detector detects that rainwater has stopped falling onto the roof.

The drive assembly may rotate the elongate trough from the second position back to the first position when the moisture detector detects that rainwater has not fallen onto the roof for a set period of time.

The set period of time may be adjustable.

The drive assembly may comprise an electric motor that operatively drives a drive shaft, and a gear assembly driven by the drive shaft, wherein the gear assembly transfers rotational movement of the drive shaft into rotational movement of the elongate trough about the longitudinal axis.

The gear assembly may comprise a first gear rotated by the drive shaft and a second gear engaged by the first gear to rotate the elongate trough about the longitudinal axis.

The first gear may comprise a bevel gear and the second gear may comprise a crown gear.

The drive assembly may further comprise an encoder to determine a rotational position of the drive shaft, and the drive assembly may rotate the elongate trough based on signals generated by the encoder.

The electric motor may be disposed inside of the building behind a fascia board of the roof, wherein the gear assembly is disposed outside of the building to engage with the elongate trough and the drive shaft extends through an aperture in the fascia board.

The electric motor may be a 12-volt electric motor.

A seal member may be provided at the aperture to seal an annular space around the drive shaft.

The drive assembly may further comprise a battery for powering the electric motor.

The drive assembly may be electrically connected to a solar power system of the building.

The drive assembly may be electrically connected to a mains power supply or power distribution circuit of the building.

The drive assembly may comprise a linear actuator, the linear actuator comprising a piston arm, and a gear assembly driven by the piston arm, wherein the gear assembly transfers linear motion of the piston arm into rotational movement of the elongate trough about the longitudinal axis.

The rotatable roof gutter system may further comprise a collector box disposed underneath the elongate trough for receiving rainwater flowing out of an outlet of the elongate trough, and the collector box may comprise a drainage outlet fluidly connected to a drainage pipe.

The elongate trough may comprise at least one peripheral open end that forms the outlet of the elongate trough, and the collector box may be disposed underneath the peripheral open end.

The elongate trough may comprise at least aperture formed in a base of the elongate trough that forms the outlet of the elongate trough, and the collector box may be disposed underneath the aperture.

The collector box may comprise a filter for catching debris in the rainwater flowing out of the outlet of the elongate trough.

The filter may comprise a mesh extending across the collector box above the drainage outlet.

A lid may be hingedly connected to the collector box for sealing a fluid inlet of the collector box.

The bracket assembly may be configured to attach the elongate trough to a fascia board of the roof.

The bracket assembly may comprise a plurality of support arms that outwardly extend from the fascia board, wherein each of the support arms rotatably supports an axle of the elongate trough, the axle extending at least in part along the longitudinal axis of the elongate trough and being operatively driven by the drive assembly.

The support arms may rotatably support a single axle of the elongate trough, wherein the single axle extends substantially along an entire length of the longitudinal axis of the elongate trough.

The bracket assembly may comprise a pair of the support arms that rotatably support, respectively, a pair of stubs axles of the elongate trough, wherein each stub axle extends partially along the longitudinal axis of the elongate trough.

The support arms may extend diagonally downwards from the fascia board.

The elongate trough may comprise a plurality of spokes projecting outwardly from the axle (or stub axles) wherein the spokes are connected to longitudinal edges of the elongate trough.

The elongate trough may be dimensioned such that one of the longitudinal edges rests on the support arms when the trough is in the first position.

### BRIEF DESCRIPTION OF DRAWINGS

Embodiments of the invention will now be described by way of example only with reference to the accompanying drawings, in which:

FIG. 1 is a schematic side elevation of a rotatable roof gutter system according to an example embodiment of the invention, wherein a trough of the system is shown in a first position;

FIG. 2 is a further schematic side elevation of the rotatable roof gutter system, wherein the trough is shown in a second position;

FIG. 3 is a schematic isometric view of a rotatable roof gutter system according to an example embodiment of the invention;

FIG. 4 shows a bracket assembly and trough of a rotatable roof gutter system according to an example embodiment of the invention;

FIG. 5 is a plan view of a rotatable roof gutter system according to an example embodiment of the invention;

FIG. 6 is a schematic isometric view of a rotatable roof gutter system according to an example embodiment of the invention; and

FIG. 7 is an isometric view of the rotatable roof gutter system of FIG. 6.

### DESCRIPTION OF EMBODIMENTS

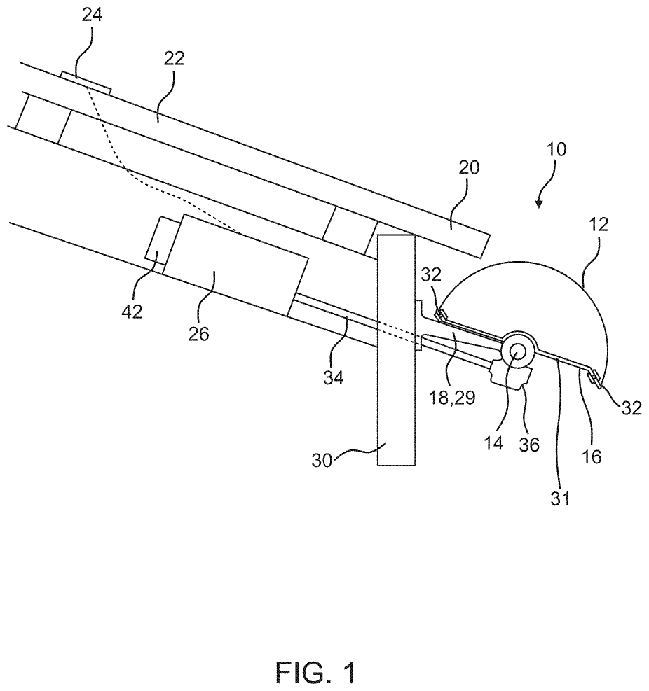

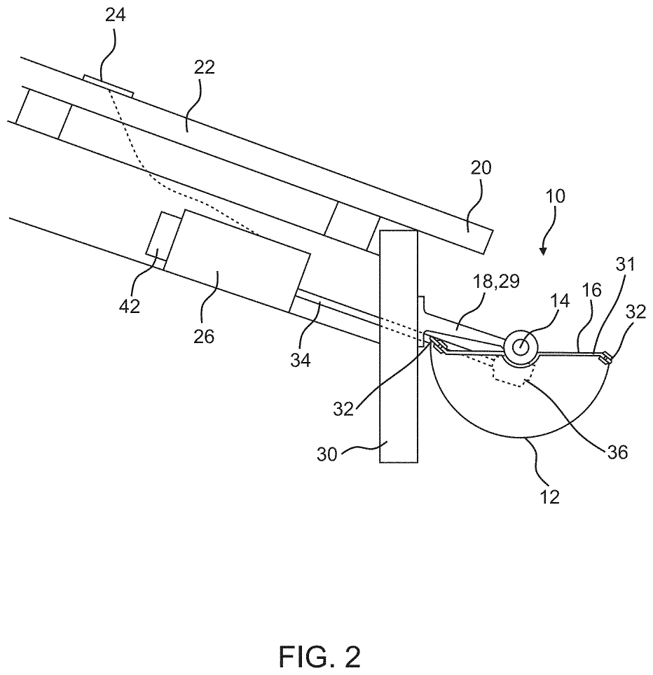

Referring to FIGS. 1 and 2, an example embodiment of the present invention provides a rotatable roof gutter system 10. The gutter system 10 comprises an elongate trough 12 that comprises a longitudinal axis 14 and an open top 16 for receiving rainwater into the elongate trough 12. The gutter system 10 also comprises a bracket assembly 18 for attaching the elongate trough 12 rotatably to a building relative to an eave 20 of a roof 22 of the building. The bracket assembly 18 is configured such that the elongate trough 12 is rotatable about the longitudinal axis 14 between a first position (FIG. 1) and a second position (FIG. 2). When the trough 12 is in the first position, the open top 16 faces away from an edge of the eave 20 that is adjacent to the trough 12. When the trough 12 is in the second position, the open top 16 is positioned to catch rainwater flowing off the edge of the eave 20. The gutter system 10 also comprises a moisture detector 24 for detecting rainwater falling onto the roof and a drive assembly 26 operatively connected to the moisture detector 24. The drive assembly 26 rotates the elongate trough 12 from the first position to the second position in response to rainwater being detected by the moisture detector 24.

More particularly, when the gutter system 10 is in dry weather conditions and no rainwater is being detected by the moisture detector 24, the trough 12 resides in the first (stowed) position as shown in FIG. 1. In the stowed position, the trough 12 is effectively inverted such that its open top 16 is downwardly facing and the curved underside of the trough 12 is upwardly facing. In this configuration, any litter falling from the roof 22 or sky onto the trough 12 (such as leaves or tree branches, etc.) hits the curved underside of the trough 12 and falls away from the trough 12. When the gutter system 10 is in wet weather conditions and rainwater is detected by the moisture detector 24, the trough 12 is rotated into the second (deployed) position as shown in FIG. 2. In this configuration, the open top 16 of the trough 12 is upwardly facing and its curved underside is downwardly facing. Rainwater falling off the edge of the roof eave 20 is, therefore, caught by the trough 12.

The gutter system 10 may comprise a controller (not shown) that is communicatively connected to the drive assembly 26 and moisture detector 24 to control the overall operation of the system 10. The controller may comprise a processor, programmable logic controller (PLC), programmable logic array (PLA) or a similar electronic controller device. The controller may be embedded into the drive assembly 26 or it may be a separate device. The controller may be configured such that it causes the drive assembly 26 to rotate the trough 12 from the stowed position into the deployed position immediately when rainwater is detected by the moisture detector 24. In one example, the controller may cause the trough 12 to be rotated back into the stowed position immediately once rainwater ceases to be detected by the moisture detector 24. In another example, the controller may cause the trough 12 to be rotated back into its stowed position once no rainwater has been detected for a set period of time. The controller may be provided with a user control device that is remotely connected to the controller and allows a human operator to adjust the set period of time that is stored in the controller. The user control device may also be used to override the controller's automatic control logic and to force the controller to rotate the trough 12 into its stowed or deployed position, should the user wish to do so. In one example, the user control device may comprise a smartphone and the controller may be remotely connectable to the smartphone via Bluetooth or WiFi. The system 10 may also comprise one or more cameras that can be used to view the position of the trough 12. Footage from the cameras may be live streamed to the smartphone so that the user can monitor and verify the position of the trough 12 in real time.

The moisture detector 24 may comprise any device that is capable of detecting moisture or rainwater. For example, the moisture detector 24 may comprise a conductivity sensor that operates by relying on the electrical conductivity of rainwater to affect the resistance across two electrical contacts monitored by the moisture detector 24.

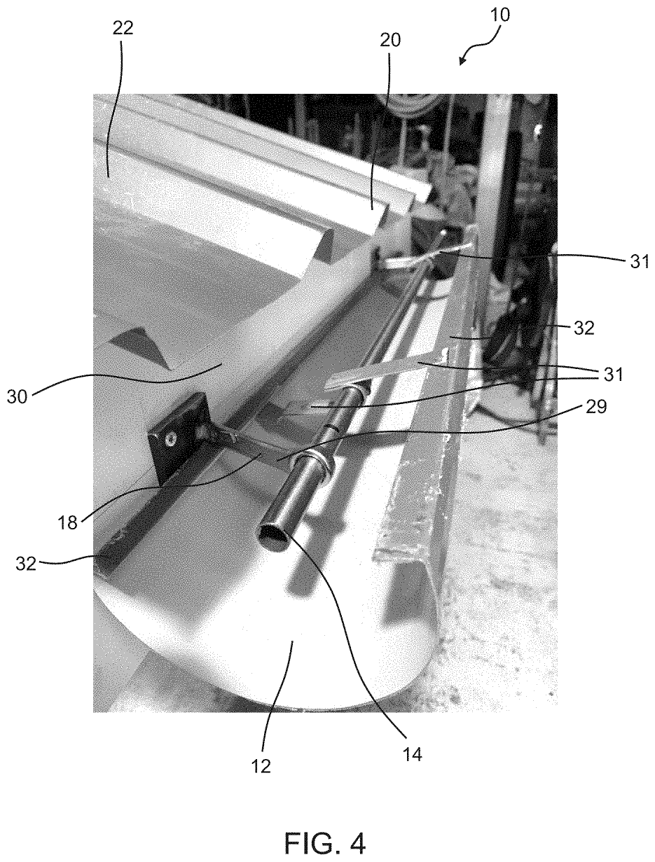

As shown in FIG. 4, the bracket assembly 18 may comprise a plurality of support arms 29 that outwardly extend from a fascia board 30 of the building underneath the roof 22. The fascia board 30 will typically be made of timber. In the example depicted, a pair of the support arms 29 are provided that are arranged at opposed ends of the trough 12. The support arms 29 may be fixed into the timber fascia board 30 by screws and may each extend diagonally downwards from the fascia board 30, as illustrated in FIGS. 1 and 2.

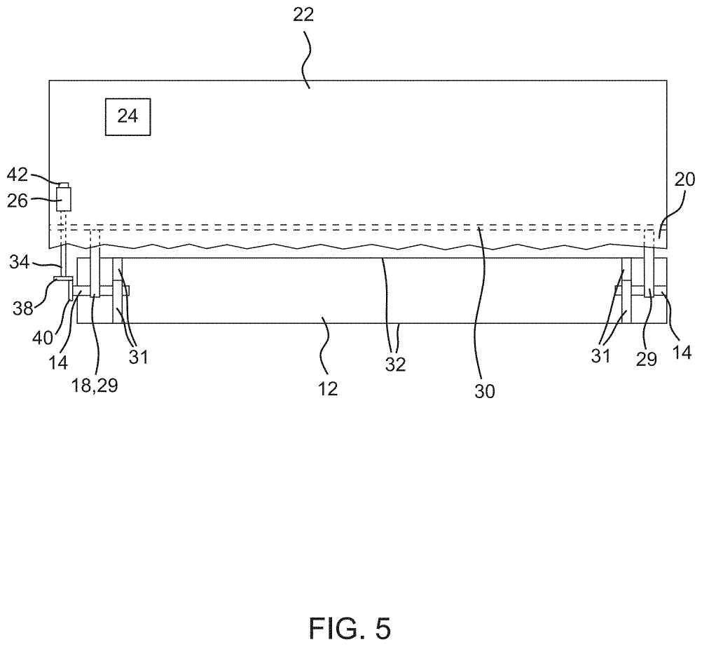

The outermost ends of the support arms 29 may comprise apertures that receive, and thereby rotatably support, an axle 14 of the trough 12 extending along the longitudinal rotational axis of the trough 12. In the example depicted in FIG. 4, the support arms 29 both support a single axle 14 that extends substantially along the complete length of the rotational axis of the trough 12. In the example depicted in FIG. 5, the support arms 29 support a pair of stub axles 14 that extend partially along the rotational axis. A plurality of spokes 31 may outwardly project from the axle (or from each stub axle 14) that are connected to opposed longitudinal edges 32 of the trough 12 to enable the trough 12 to rotate about its longitudinal axis. The spokes 31 may comprise pressed metal straps (e.g., lengths of hoop iron) that are clipped, welded or riveted to the trough edges.

As best shown in FIGS. 1 and 2, the trough 12 may be semicircular in cross section and the axle 14 (or stub axles 14) may be arranged towards the open end 16 of the trough 12. In this configuration, a first of the longitudinal edges 32 of the trough 12 may rest on the topmost surfaces of the support arms 29 when the trough 12 is in its stowed position, as shown in FIG. 1. A second of the longitudinal edges 32 of the trough 12 may be positioned immediately underneath the support arms 29 when the trough 12 is rotated into its deployed position, as shown in FIG. 2. The drive assembly 36 is shown using broken lines in FIG. 2 in order to allow the position of the second longitudinal edge 32 to be clearly shown. The trough 12 may be made of sheet metal or a tough plastic-based material. In one example, the trough 12 may be made of a steel-based material coated in paint, such as the steel product commercially available under the name COLORBOND® steel.

The drive assembly 26 may comprise a brushed or brushless electric motor that operatively drives a drive shaft 34. A gear assembly 36 may be provided at an end of the drive shaft 34 that transfers rotational movement of the drive shaft 34 into rotational movement of the trough 12. Referring to FIG. 5, the gear assembly 36 may comprise a first gear 38 connected to the end of the drive shaft 34 and a second gear 40 connected to an end of the axle 14, or to an end of one of the stub axles 14. The first gear 38 may be a bevel gear contained inside a protective housing of the gear assembly 36 and the second gear 40 may be crown gear. The crown gear 40 may be engaged and rotated by the bevel gear 38 through an aperture provided in the housing. The drive shaft 34 may rotate the bevel gear 38 which, in turn, rotates the crown gear 40 and trough 12.

The electric motor 26 may comprise an encoder 42 that determines a rotational position of the drive shaft 34. The encoder 42 may be a mechanical or optical rotary encoder that generates signals based on the current rotational position of the drive shaft 34 during use. The encoder signals may be received by the controller of the gutter system 10. The controller may use the signals to adjust the rotational position of the driven axle or stub axle 14 in a controlled and accurate manner when the trough 12 is being moved back and forth between its stowed and deployed positions.

The electric motor 26 may be disposed underneath the roof 22 of the building behind the fascia board 30 so that the motor 26 is shielded from the weather and environmental conditions. The gear assembly 36 may be disposed outside of the building such that it engages the trough 12. The drive shaft 34 may extend diagonally from the motor 26 to the gear assembly 36 via an aperture formed in the fascia board 30. The diameter of the aperture may be sufficiently large such that the drive shaft 34 and gear assembly 36 may be passed through the aperture during installation of the gutter system 10. A seal member, such as an annular silicone or rubber grommet, may be provided at, or within, the aperture to seal the annular space around the drive shaft 34.

The electric motor 26 may be a 12-volt electric motor and may be powered by a battery and/or solar power system of the building. The electric motor may also, or alternatively, be connected to a mains power or power distribution circuit of the building and may be provided with a transformer and rectifier for providing the correct power to the motor.

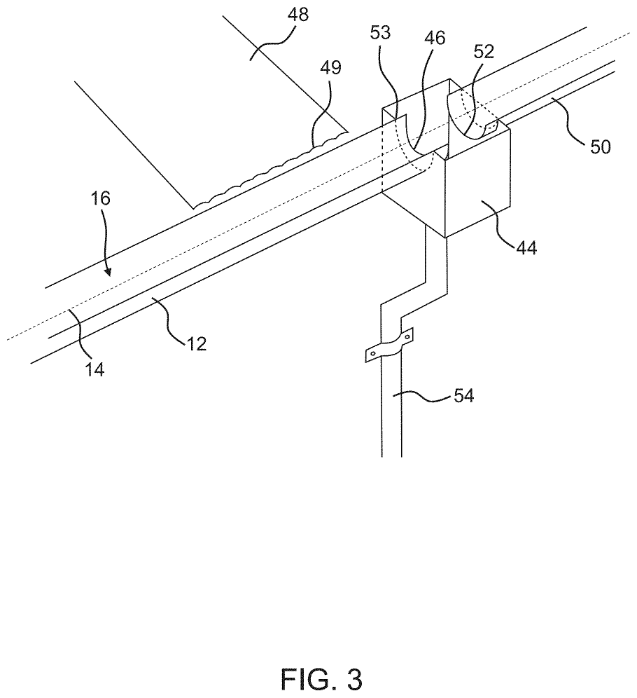

The roof gutter system 10 may comprise multiple rotatable troughs that are arranged around the eave of a building. Each trough may be configured to operate the same way as the example troughs described in the foregoing paragraphs and may interface with one or more drainage systems. For example, referring to FIG. 3 the roof gutter system 10 may further comprise a collector box 44 that is disposed directly underneath a peripheral open end 46 of the trough 12. The trough 12 is depicted in simplified form in FIG. 3 without the bracket assembly 18 or drive assembly 26 shown and with only a single portion of roof sheeting 48 above the trough 12 shown. An edge 49 of the roof sheeting 48 overhangs the trough 12. The trough 12 is arranged next to a second trough 50 of the system 10. The second trough 50 is configured the same way as the first trough 12 as is, therefore, also rotatable between stowed and deployed positions. The second trough 50 has a peripheral open end 52 positioned above the collector box 44. The collector box 44 may comprise a pair of semicircular apertures 53 at its topmost end that provide bearing surfaces that receive end sections of the troughs 12, 50. The collector box 44 is, therefore, positioned and configured to receive rainwater flowing out of the two open trough ends 46, 52. The semicircular bearing surfaces may be lined with Neoprene to provide a fluid seal between the collector box 44 and troughs 12, 50. In the example depicted, each trough is aligned at a right angle to the collector box 44. However, it will be appreciated that in other examples the troughs may be arranged at different angles relative to the box 44 in order to accommodate the particular shape and profile of the building eave that the troughs are attached to.

A base of the collector box 44 may comprise a drainage outlet that is fluidly connected to a drainage downpipe 54. The collector box 44 may also comprise a filter, such as an apertured mesh, that extends across the hollow interior of the collector box above the fluid outlet. The filter traps any debris or litter, such as leaves, that may be suspended in rainwater flowing into the box 44 so as to avoid the box 44 and downpipe 54 from getting blocked. A lid (not shown) may be hingedly connected to a fluid inlet of the collector box 44 at its top end. The lid may allow the inlet to be sealed during dry weather conditions when the gutter system 10 is dormant to prevent ingress of debris and litter into the collector box 44. The lid may be electronically actuated and connected to the controller such that the controller causes the lid to open when rainwater is detected by the system 10.

The roof gutter system 10 may comprise a single master controller and moisture detector that controls the rotational position of both troughs 12, 50. In other examples, each trough 12, 50 may comprise its own individual controller and moisture detector. The moisture detector(s) may be located at any position on the building that enables water falling onto the roof to be effectively detected. This includes rainwater and any tap water that may be sprayed onto the roof using a hose from time to time (for example, when the roof or solar panels mounted thereon need to be cleaned). For climates in which rain-bearing weather systems commonly approach from a particular geographical direction, the moisture detector(s) may be mounted onto the roof at an end or corner of the roof that faces such direction.

In use, in dry weather conditions when no rainwater is detected by the roof gutter system 10, each trough 12, 50 resides in its stowed position. Each trough 12, 50 stays effectively inverted during such conditions so that its open top end 16 faces away from the edge of the roof eave. In this configuration, any debris or litter falling onto a trough 12, 50 hits the curved underside of the trough and falls away. Each trough 12, 50 is, therefore, advantageously adapted to avoid accumulation of debris and litter. In wet weather conditions when rainwater is detected by the system 10, each trough 12, 50 is automatically rotated into its deployed position such that its open top end 16 faces the edge of the roof eave, as depicted in FIG. 3. Rainwater falling off the eave is, therefore, able to fall into the troughs and drain into the collector box 44.

The collector box 44 shown in FIG. 3 may be used in examples where the downpipe 54 needs to be placed away from the corners of the roof of the building. In other examples, the collector box 44 may be arranged at a corner of the building and one or more troughs 12 may have an open end draining into the collector box 44.

In other examples, the trough ends 46, 52 may be closed and, instead, each trough 12, 50 may comprise an aperture formed in its base that provides a drainage outlet of the trough. The aperture may be located anywhere along the length of the trough but will commonly be located at a centre of the trough. A collector box 44 and downpipe 54 may be provided underneath each aperture for draining rainwater flowing out of the aperture.

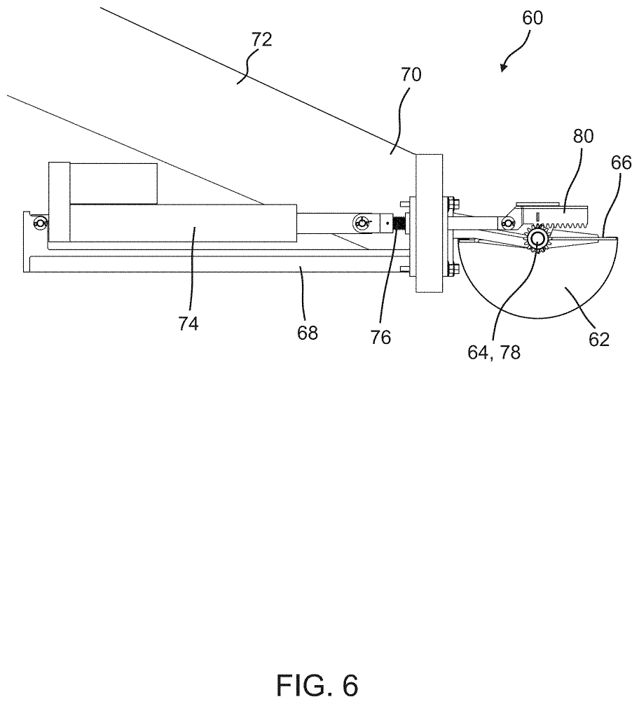

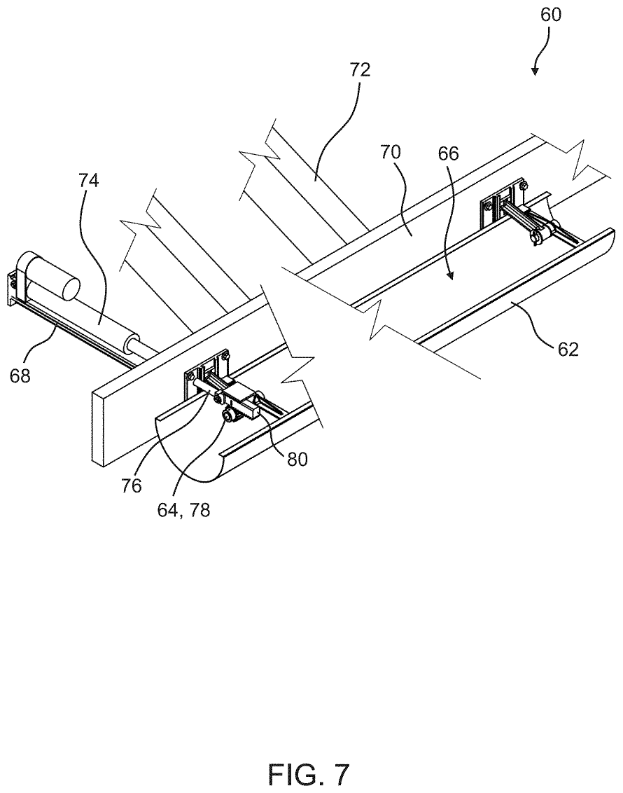

Referring to FIGS. 6 and 7, a rotatable roof gutter system 60 is depicted according to a further embodiment of the invention. The system 60 comprises an elongate trough 62 that comprises a longitudinal axis 64 and an open top 66 for receiving rainwater into the elongate trough 62. The gutter system 60 also comprises a bracket assembly 68 for attaching the elongate trough 62 rotatably to a building relative to an eave 70 of a roof 72 of the building. The bracket assembly 68 is configured such that the elongate trough 62 is rotatable about the longitudinal axis 64 between a first (stowed) position and a second (deployed) position. When the trough 62 is in the stowed position, the open top 66 faces away from an edge of the eave 70 that is adjacent to the trough 62. When the trough 62 is in the deployed position (as depicted in FIGS. 6 and 7), the open top 66 is positioned so that the trough 62 catches rainwater flowing off the edge of the eave 70. The gutter system 10 also comprises a moisture detector for detecting rainwater falling onto the roof 72 and a drive assembly 74 operatively connected to the moisture detector. The drive assembly 74 rotates the trough 62 from its stowed position to its deployed position in response to rainwater being detected by the moisture detector.

More particularly, the drive assembly 74 comprises a linear actuator comprising a piston arm 76. The arm 76 is connected to a rack and pinion gear arrangement that comprises a circular gear 78 that is engaged by a linear gear 80 at an end of the arm 76. The circular gear 78 is connected to the axle 64 of the trough 62 and is rotated by the arm 76 and linear gear 80 so as to rotate the trough 62 back and forth between its stowed and deployed positions. The linear actuator may comprise an electrical, hydraulic or pneumatic linear actuator. For simplicity, the actuator may be an electrical linear actuator that is directly connectable to an electrical power source provided within the building, such as a battery or a solar or mains power system. In other examples, instead of the rack and pinion gear arrangement, the drive assembly 74 may comprise a lever arm (not shown) that is fastened radially to the axle 64 and connected pivotably to the piston arm 76 to transfer linear motion of the arm 76 into rotational motion of the axle 64.

In the example shown in FIG. 6, the linear actuator 74 is horizontally arranged and the arm 76 extends horizontally through the fascia board of the eave 70 of the roof 72. In other examples, the linear actuator 74 and arm 76 may be diagonally arranged at the same angle as the pitch of the roof structure —i.e., similar to the actuator drive assembly 26 shown in FIGS. 1 and 2. In such examples, the arm 76 may be connected to the linear gear 80 using a universal type joint or pivot lever to convert the angled stroke of the arm 76 to the horizontal stroke of the rack and pinion running through the fascia board. This configuration allows the actuator 74 to be hidden when viewed from underneath the trough 62. A soffit lining may be fixed to the underside of the overhanging roof rafters in such examples.

Now that example embodiments of the roof gutter system have been described, it will be apparent that it provides a number of advantages over the prior art, including the following:
(i) Because each trough remains inverted during dry conditions, the accumulation of debris and litter is alleviated which helps to prevent drainage issues and blockages from occurring;
(ii) Alleviating the accumulation of debris and litter also mitigates fire risk;
(iii) When each trough is inverted, the trough can be conveniently cleaned by upwardly directing a jet of water into its open top end when standing underneath the trough on the ground;
(iv) In cold climates, when each trough is inverted any snow sliding off the eave of the roof does not collect in the trough. The damage that can be caused by heavy snow build up is, therefore, avoided;
(v) When wet conditions are encountered, each trough is automatically rotated into its deployed position and provides an effective means for catching and draining rainwater flowing off the roof.

For the purpose of this specification, the word “comprising” means “including but not limited to”, and the word “comprises” has a corresponding meaning. It is to be understood that, if any prior art is referred to herein, such reference does not constitute an admission that the prior art forms a part of the common general knowledge in the art, in Australia or any other country.

The above embodiments have been described by way of example only and modifications are possible within the scope of the claims that follow.

1. A rotatable roof gutter system, comprising:
an elongate trough that comprises a longitudinal axis and an open top for receiving rainwater into the elongate trough;
a bracket assembly for attaching the elongate trough rotatably to a building relative to an eave of a roof of the building, wherein the bracket assembly is configured such that the elongate trough is rotatable about the longitudinal axis between a first position and a second position, whereby in the first position the open top faces away from an edge of the eave and in the second position the open top is positioned to catch rainwater flowing off the edge of the eave;
a moisture detector for detecting rainwater falling onto the roof; and
a drive assembly operatively connected to the moisture detector, wherein the drive assembly rotates the elongate trough from the first position to the second position in response to rainwater being detected by the moisture detector.

2. The rotatable roof gutter system according to claim 1, wherein the drive assembly rotates the elongate trough from the second position back to the first position when the moisture detector detects that rainwater has stopped falling onto the roof.

3. The rotatable roof gutter system according to claim 2, wherein the drive assembly rotates the elongate trough from the second position back to the first position when the moisture detector detects that rainwater has not fallen onto the roof for a set period of time.

4. The rotatable roof gutter system according to claim 3, wherein the set period of time is adjustable.

5. The rotatable roof gutter system according to claim 1, wherein the drive assembly comprises:
an electric motor that operatively drives a drive shaft; and
a gear assembly driven by the drive shaft, wherein the gear assembly transfers rotational movement of the drive shaft into rotational movement of the elongate trough about the longitudinal axis.

6. The rotatable roof gutter system according to claim 5, wherein the gear assembly comprises a first gear rotated by the drive shaft and a second gear engaged by the first gear to rotate the elongate trough about the longitudinal axis.

7. The rotatable roof gutter system according to claim 6, wherein the first gear comprises a bevel gear and the second gear comprises a crown gear.

8. The rotatable roof gutter system according to claim 5, wherein the drive assembly further comprises an encoder to determine a rotational position of the drive shaft and the drive assembly rotates the elongate trough based on signals generated by the encoder.

9. The rotatable roof gutter system according to claim 5, wherein the electric motor is disposed inside of the building behind a fascia board of the roof and wherein the gear assembly is disposed outside of the building to engage the elongate trough, the drive shaft extending through an aperture in the fascia board.

10. The rotatable roof gutter system according to claim 9, wherein a seal member is provided at the aperture to seal an annular space around the drive shaft.

11. The rotatable roof gutter system according to claim 5, wherein the drive assembly further comprises a battery for powering the electric motor.

12. The rotatable roof gutter system according to claim 5, wherein the drive assembly is electrically connected to a solar power system of the building.

13. The rotatable roof gutter system according to claim 1, wherein the drive assembly comprises:
a linear actuator comprising a piston arm; and
a gear assembly driven by the piston arm, wherein the gear assembly transfers linear motion of the piston arm into rotational movement of the elongate trough about the longitudinal axis.

14. The rotatable roof gutter system according to claim 1, wherein the elongate trough comprises at least one peripheral open end, and wherein the rotatable roof gutter system further comprises a collector box disposed underneath the peripheral open end for receiving rainwater flowing out of the peripheral open end, wherein the collector box comprises a drainage outlet fluidly connected to a drainage pipe.

15. The rotatable roof gutter system according to claim 14, wherein the collector box comprises a filter for catching debris in the rainwater flowing out of the peripheral end of the elongate trough.

16. The rotatable roof gutter system according to claim 15, wherein the filter comprises a mesh extending across the collector box above the drainage outlet.

17. The rotatable roof gutter system according to claim 1, wherein the bracket assembly is configured to attach the elongate trough to a fascia board of the roof.

18. The rotatable roof gutter system according to claim 17, wherein the bracket assembly comprises a plurality of support arms that outwardly extend from the fascia board, wherein each of the support arms rotatably supports an axle of the elongate trough, the axle extending at least in part along the longitudinal axis of the elongate trough and being operatively driven by the drive assembly.

19. The rotatable roof gutter system according to claim 18, wherein the support arms extend diagonally downwards from the fascia board.

20. The rotatable roof gutter system according to claim 18, wherein a plurality of spokes project outwardly from the axle, wherein the spokes are connected to longitudinal edges of the elongate trough.
